(19) United States
(12) Patent Application Publication
(10) Pub. No.: US 2012/0319595 A1
(43) Pub. Date: Dec. 20, 2012

(54) Separable, keyed electrical/electronic modules for mating to LED lighting assemblies

(76) Inventors: Nicholas Antonopoulos, San Jose, CA (US); Arockiyaswamy Venkidu, Saratoga, CA (US); Joseph Fjelstad, Maple Valley, WA (US)

(21) Appl. No.: 13/507,080

(22) Filed: May 31, 2012

Related U.S. Application Data
(60) Provisional application No. 61/519,920, filed on May 31, 2011.

(51) Int. Cl. H05B 37/02; H01J 5/50

(52) U.S. Cl. 315/152; 313/51; 315/313; 315/200 R

(57) ABSTRACT

An LED lighting element comprised of at least two pieces designed for use with legacy lighting fixtures having a separable transformer and lighting element to improve efficacy and economy of LED lighting. In addition, the assembly can be provided with intelligent electronics for wireless control, operation and monitoring and/or with a battery for operation during power outages and/or as a warning system for the hearing impaired by stroboscopically flashing the LED lights and/or as sensing elements which cause activation due to some other sensed stimulus.

### RELATED APPLICATION

The present application claims priority to provisional patent application U.S. 61/519,920 entitled Separable, Keyed Transformers for LED lighting Assemblies, filed May 31, 2011, the contents of which are incorporated herein by reference in their entirety.

### FIELD OF THE INVENTION

The present invention relates to the field of electrical/electronic lighting, specially LED lighting and the AC to DC transformer electronics required to operate them

### BACKGROUND

It has been suggested in various reports that more than half of the total energy produced in the US is wasted due to inefficiencies including waste heat from power plants, vehicles and light bulbs. In the US alone, lighting consumes approximately 12% of the total energy used. This is not an insignificant amount of energy especially when one accounts for the waste. While efforts to effect changes are underway, incandescent lighting technology, which is well over 125 years old, persists. Such bulbs waste most of the electricity because in operation more of the energy used is turned into heat rather than light. Such inefficiencies are well known. In fact, incandescent lights produce only 10-20 lumens per watt whereas a present day alternative competitive solutions such as compact florescent lighting can produce 50-90 lumens per watt. With knowledge of this wasteful situation, the fact that there are alternatives and to encourage energy efficiency, the United States Congress passed a law in 2007 mandating that bulbs producing 100 watts worth of light meet certain efficiency goals, starting in 2012. Because conventional light bulbs cannot meet those goals, the law is poised to prohibit either making or importing them. The same rule will start apply to remaining bulbs 40 watts and above in the year 2014. Moreover there have been proactive efforts at the state level in the promotion of more energy efficient lighting. For example, California has already banned stores from restocking 100-watt incandescent bulbs.

While compact florescent lighting (CFL) has been popular from an energy savings standpoint, the lamps have the disadvantage of requiring use of mercury to operate making them a potential environmental hazard both in home use and in disposal. As a result, light emitting diode (LED) lighting technology which has been developing at a rapid pace over the last several years is proving a very efficient solution capable of producing even more light than CFLs at lower wattage. The energy savings that could be realized by simply replacing even all 40 watt incandescent bulbs with 10-watt LED bulbs is staggering and thus to stimulate LED development, the federal government has instituted a $10 million “L Prize” for an energy-efficient replacement for the 60-watt bulb giving added weight to the importance of efficient lighting solutions to the nation's future.

Creating good alternatives to the light bulb has been more difficult than expected, especially for the very bright 100-watt bulbs. Part of the problem is that these new bulbs have to fit into lamps and ceiling fixtures designed for older technology. CFLs are the most obvious replacement but they have drawbacks. They contain a small amount of toxic mercury vapor, which is released if they break or are improperly thrown away. They last longer than traditional bulbs but not as long as LEDs. Moreover, brighter models of CFLs are bulky and may not fit in existing fixtures.

Another new lighting technology, organic light-emitting diodes, or OLEDs, has had problems reaching mass production. OLEDs are glowing sheets or tiles, rather than pinprick light sources, as LEDs are. They're used as vibrant color screens for smart phones, such as those from Samsung Electronics Co. Unfortunately, making OLEDs that are big, bright, cheap and long-lasting enough for use as light sources has proved difficult. This is in part due to the fact that they use chemicals that are sensitive to oxygen and spoil unless sealed very carefully. Some OLED panels are coming to market but the price will likely make them technology showpieces rather than candidates for everyday lighting.

In contrast, LEDs are efficient, durable and are produced in great quantities. While they are a rapidly emerging type of lighting, they are still expensive. An LED bulb can contain a dozen or more light-emitting diodes, which are tiny semiconductor chips, costing up to $1.00 each.

While LEDs do not produce as much heat as incandescent bulbs, they still produce substantial heat that shortens their lifespan and reduces the efficiency of the chips. And placing a dozen chips tightly spaced together to conform to a bulb-shaped package that will fit in today's legacy lamps and sockets makes the heat problem worse. Moreover, the brighter the bulb, the bigger the heat problem is.

The most powerful pear-shaped LED bulbs in stores today, the type that mimic traditional bulb design and which fit into existing lamps sockets, produce light equivalent to a 60-watt bulb. However, there are even more powerful LED bulbs for directional or flood lighting. Solving the heat management problem has been an important objective for addressing the life of the LED but it also impacts the life of the transformer electronics used to convert standard home AC current into the DC current required for LED operation. One developer, Lighting Sciences Group Corp. has shown 100-watt-equivalent LED lamp prototypes designed to manage the problem of cooling the LEDs by using microscopic devices that move air over the chips, like miniature fans; a solution which is clever but also expensive. However, LED prices are coming down quickly and the US Department of Energy expects a 60-watt equivalent LED bulb to cost $10 by 2015, putting them within striking range of the price of a compact fluorescent bulb.

Thus electrical lighting solutions, where the light is provided by means of light emitting diodes (LEDs) are anticipated to dominate the lighting market in the coming years. The reasons are manifold but chief among them are improved lamp longevity and better efficiency in terms of lumens per watt. With continuing improvements in LED technology at the chip, packaging and phosphor development levels, it is anticipated that the price and performance of LEDs will soon match that of current benchmark energy efficient technologies such as compact florescent lamp technology.

There is, however an added advantage to LEDs and that is related to prospective longevity. LEDs have been proven capable of achieving operational longevities of up to 70,000 hours. Unfortunately, however, the supporting electronic assemblies that are combined with the LED lamps to transform nominal line alternating current (AC) commercially used voltages in the homes around the world (e.g., 110V to 250V) into lower direct current (DC) voltages (e.g., 3V to 5V) required to operate LEDs have proven to be a weak link; they are commonly fail well in advance of the LED lamps. Thus when the transformer fails for any reason, such as the failure of a capacitor, the entire lighting assembly is rendered useless. That is, unless the owner repairs the transformer (a task that is normally beyond the skills of the vast majority of lighting consumers) or has a skilled technician disassemble and repair the electrical transformer circuit. In either case the cost of the repairs will often exceed the cost of purchasing a new lighting element.

### BRIEF SUMMARY OF THE INVENTION

Given the current situation, it is obvious that significant benefit could be gained by creating a simple lighting repair solution which can be effected by the average consumer in a fool-proof manner and one which would obviate the need to discard an entire LED lighting assembly when only one portion of it normally fails (i.e., the transformer circuitry). This will result in a significant amount of savings to the user by extending the life of their light fixtures and will result as well in environmental benefit to society at large by reducing electrical and electronic waste.

One way to accomplish these beneficial objectives is to create a lighting assembly which is comprised of separate lamp and transformer elements which can be joined for use in a lighting fixture. The concept of an adapter for florescent lighting has been described by Broyer et all in U.S. Pat. No. 5,202,607 but the scope of the solution was limited to the adaptation of two lamps to a common base and did not anticipate the LED application which is unique and also can provide additional benefits (e.g., making the bulb assemblies “smart” thus allowing them to communicate amongst and between lights and serving as a communications network in which information is carried on selected wavelengths of emitted and received light). A feature of the present invention is that when a transformer element fails before the LED element, the transformer can be easily and accurately changed out by the average consumer and the lamp can be used to the end of its functional life, which in the case of certain LED assemblies might be as many as 10 to 20 times longer than the typical transformer.

While the concept described above encompasses the fundamental nature of the invention, there are many prospective embodiments which can be and are envisioned to service the diversity of lighting standards and infrastructure which are found around the world. For example home use light bulbs have traditionally been joined to sockets by one several different means, however perhaps the most ubiquitous is the Edison screw fitting where the two electrodes of the light bulb are comprised of the metal tip of the insulated base of the base of the screw assembly and a matching metal walled screw socket which supports the base of the bulb. The medium or standard Edison screw fitting is the size E26 in North America and E27 in Europe.

Edison screw-cap fittings include:

| | Base | | IEC 60061-1 |
|---|---|---|---|
| | Diameter | Name | standard |
| E5 | 05 mm | Lilliput Edison Screw (LES) | 7004-25 |
| E10 | 10 mm | Miniature Edison Screw (MES) | 7004-22 |
| E11 | 11 mm | Mini-Candelabra Edison Screw | 7004-06-1 |
| | | (mini-can) | |
| E12 | 12 mm | Candelabra Edison Screw (CES) | 7004-28 |
| E14 | 14 mm | Small Edison Screw (SES) | 7004-23 |
| E17 | 17 mm | Intermediate Edison Screw (IES) | 7004-26 |
| E26 | 26 mm | Medium (one-inch) Edison Screw | 7004-21A-2 |
| | | (ES or MES) | |
| E27 | 27 mm | [Medium] Edison Screw (ES) | 7004-21 |
| E29 | 29 mm | [Admedium] Edison Screw (ES) | |
| E39 | 39 mm | Single-contact (Mogul) Giant Edison | 7004-24-A1 |
| | | Screw (GES) | |
| E40 | 40 mm | (Mogul) Giant Edison Screw (GES) | 7004-24 |

More information on Edison screw fittings is available on the Wikipedia website entry entitled “Edison screw.”

Other fittings are used in different countries and regions around the globe. In India, for example, an electrode base mount involves two electrodes both located at the bottom of the support base that are connected for powering the light by mating to two corresponding metal contacts on the receptacle. Other lamp bases include the bayonet mount and wedge base. Thus embodiments which serve the world's present infrastructure would be advantageous, still, these solutions may prove less than optimal and new methods may be required.

Because the electronics in the present invention are made separable from the LED assembly, it is possible to provide additional functionality to the electronics of the transformer assembly. Examples include wireless monitoring of the lighting assembly and/or operation of the bulb for dimming or turning on and off the LEDs or adjusting lighting in combination with any ambient light coming through windows to create a constant lumen level within a given environment. This offers other prospective benefits which include the possibility of programming lighting systems wherein a larger number of discrete LED lamps are in an array and could programmed to turn on and off in a display to provide alpha numeric patterns to provide information or artistic patterns for aesthetic purposes. Where colored LEDs are used, colors can be altered to create different lighting effects.

The electronic portion of the separable assembly could also be provided with other features as well such as a battery which can activate during emergencies to provide lighting in darkened and/or stroboscopic effects to warn those who may be hearing impaired.

Other possible features which could be made part of the assembly include charging circuits which could be served either by the standard utility supplied power or by solar cells during the day. Additional set of interconnecting pins and circuits could be provided in the assembly to allow for such additional capabilities. Under certain circumstances it might be advantageous to incorporate a solar cell directly into the assembly or make provision for one to be easily attached.

Finally, a sensing system such as a MEMS (micro electromechanical system) device may be incorporated into the electrical/electronic assembly which allows the lighting to be activated or deactivated by any sensing system that does not require hard wiring or manual actions to activate the lighting assembly but which is activated by some other means including but not limited to: motion, vibration, sound, temperature, moisture or chemical sensing activators.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A and FIG. 1B provide an example of one embodiment of the invention showing two elements of a LED lighting assembly.

FIG. 2 illustrates the two elements of FIG. 1A and FIG. 1B removably connected and ready for placement into a lighting fixture.

FIG. 3A and FIG. 3B provide an example of a second embodiment of the invention showing two elements of a LED lighting assembly which can be plugged together.

FIG. 4A illustrates the two elements of FIG. 3A and FIG. 3B removably connected to one another and ready for installation into a lighting fixture.

FIG. 4B illustrates two elements of a third embodiment removably connected to one another and ready for installation into a lighting fixture.

FIG. 5A and FIG. 5B illustrate one embodiment of the invention related to a keying feature to ensure proper connection and polarity.

FIG. 6A, FIG. 6B, FIG. 6C, FIG. 6D, FIG. 6E, FIG. 6F, FIG. 6G, and FIG. 6H provide non-exclusive examples of embodiments which ensure both proper polarity and mating between appropriately matched transformer and lighting elements.

FIG. 7A, FIG. 7B, FIG. 7C, and FIG. 7D show non-exclusive example embodiments of different openings into which mating elements can be placed.

FIG. 8A and FIG. 8B show a prospective configuration for a mated pair of transformer and lighting module with a keying pin to ensure proper polarity is achieved.

FIG. 9A and FIG. 9B shows a perspective of another embodiment where a male and female connector pair are provided to both ensure alignment and to provide connections for auxiliary electrical functions

### BRIEF DESCRIPTION OF THE INVENTION

In the following descriptions and in the accompanying drawings, specific terminology and drawing symbols are set forth to provide a thorough understanding of the present invention. In some instances, the terminology and symbols may imply specific details that are not required to practice the invention.

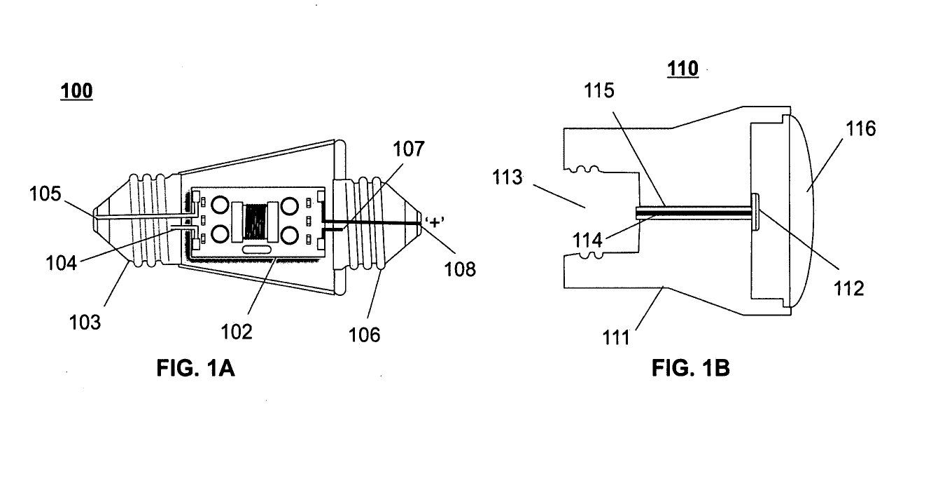

FIG. 1A and FIG. 1B show an embodiment of the invention in cross section with two halves of an assembly, transformer section 100 and LED lamp assembly 110. The transformer section 100 is designed to fit an existing socket. The illustration shows a metallic screw thread 103 commonly used in many places around the world. It is illustrative only and has two terminations one at tip 105 and the other termination 104 connected to screw 103. Because alternating current (AC) must be necessarily converted to direct current (DC) by transformer 102 for use with the LED lamp assembly 110 having a protective lens 116, and because LED lighting element 112 must be connected with proper polarity, one feature of the present invention ensures that polarity is not reversed (i.e. the positive of one half 108 of the mating must always connect with its positive mate 104 and likewise negative 107 which is connected to an illustrative screw 106 with negative LED connection 111 by way of connecting path 114 which is insulated by a suitable material 115 such as a insulating polymer (e.g. PVC) or refractory material (Al2O3)). The body of the assembly 110 may also serve the function of a heat sink and has an aperture 113 to accept the screw in electronics.

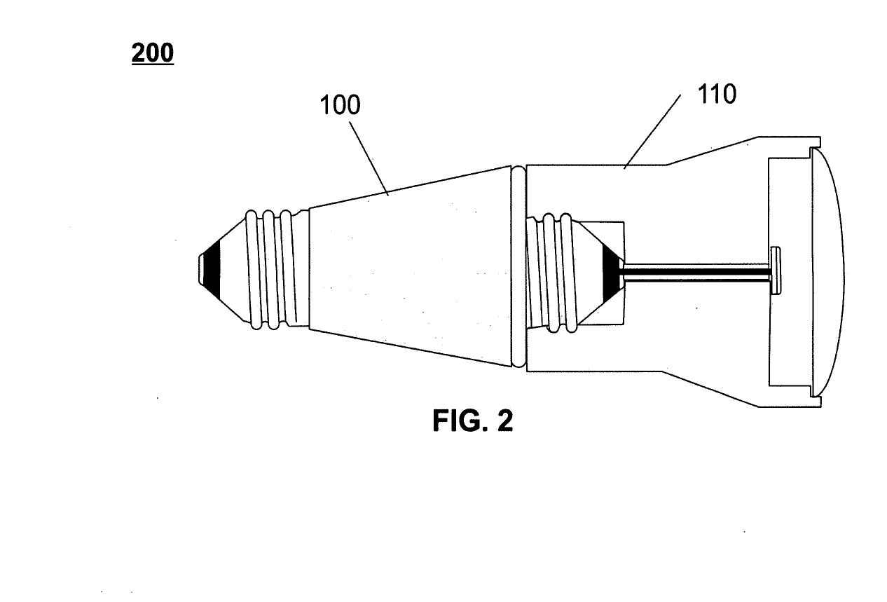

FIG. 2 shows the transformer section 100 and the LED lamp assembly 110 joined to form assembly 200.

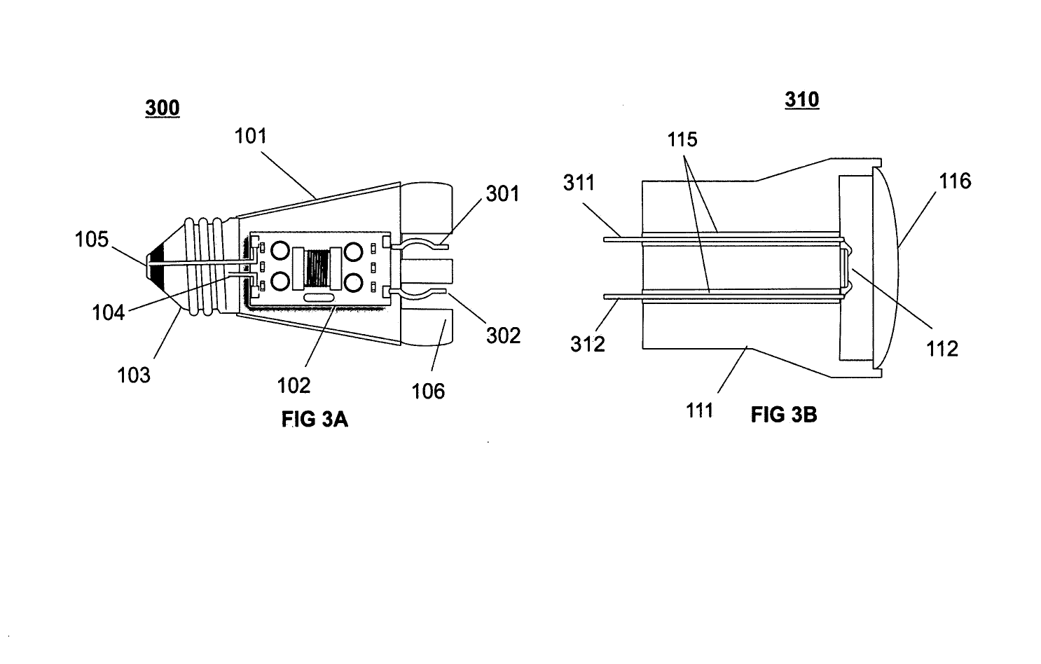

FIG. 3A and FIG. 3B shows another embodiment of the invention wherein DC connections 301 and 302 for electronics housed in assembly 300 are recessed for increased user safety much like standard wall sockets even though the DC voltages are rather low. The LED assembly 310 has connections 311 and 312 which may be inserted into the recesses to make connection to DC connections 301 and 302 respectively. This embodiment shows LED lighting element 112 having both connections on the same side of the chip (in contrast to chips having connections on top and bottom surfaces). This arrangement is illustrative only, being but one common connection of those known to persons of ordinary skill in the art.

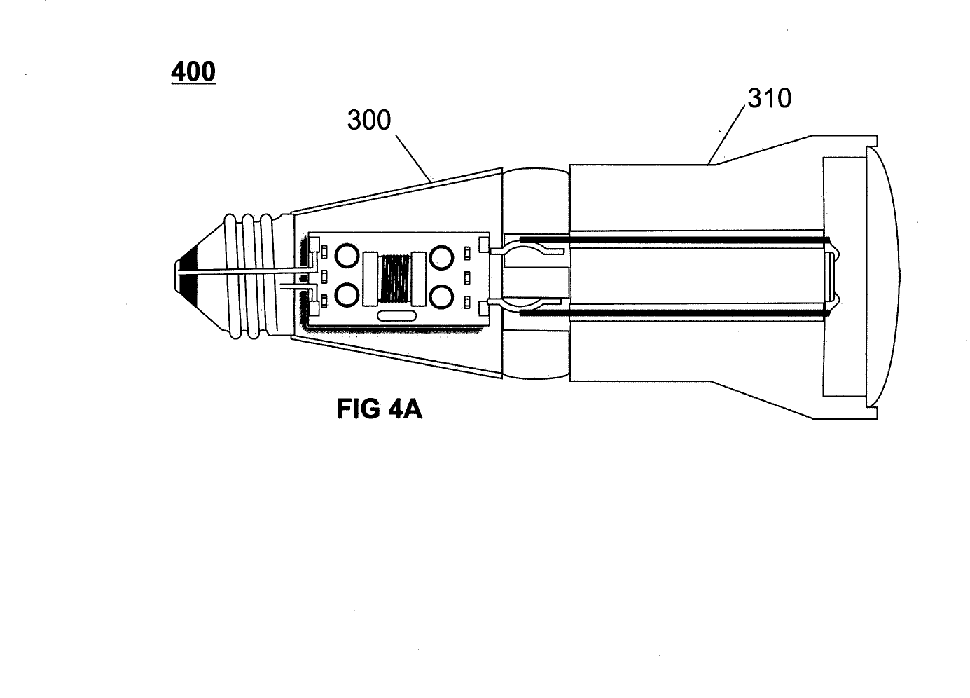

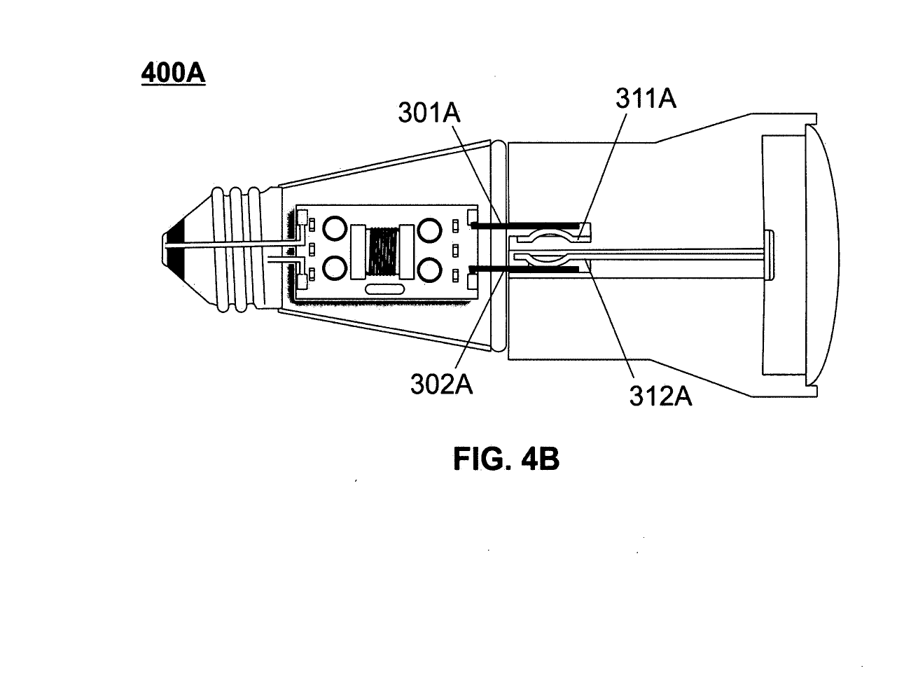

FIG. 4A shows assembly 300 mated to LED assembly 310 to form combined assembly 400.

FIG. 4B shows alternate assembly 400A in which DC connections 301A and 302A are elongated and connections 311A and 312A are recessed.

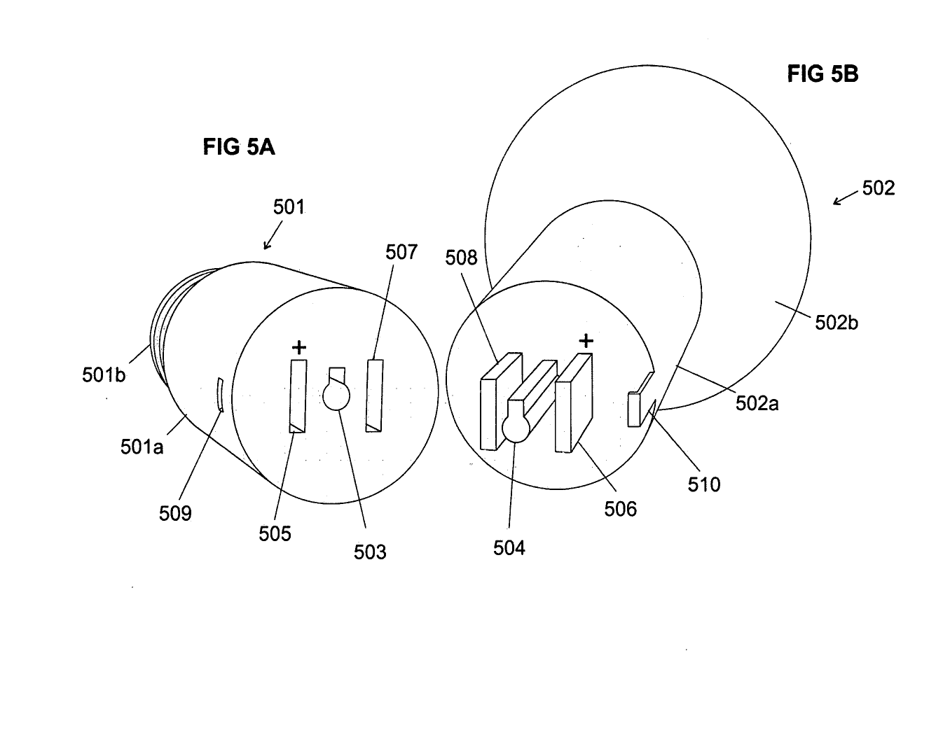

FIG. 5A and FIG. 5B illustrate one embodiment of the invention in a perspective view of two halves, assembly 501 and LED assembly 502, of a lighting assembly. The separable electronics are housed in housing 501a with a lighting fixture connector 501b. Connector 501b is shown as a screw in version but any commonly known method can be used. In the LED assembly 502, segment 502a provides a means for connecting to the assembly 501. Enclosure 502b houses LED lamps. The embodiment as shown would ensure the proper mating of the two assembly halves, assembly 501 and LED assembly 502, by mating a key slot 503 with key pin 504 to ensure proper orientation and polarity. The key pin 504 would desirably be of a length greater than power pin 506 and power pin 508 so that key pin 504 is inserted into key slot 503 before power pin 506 makes contact with slot 505 and before power pin 508 makes contact with slot 507.

Still, as mentioned in the summary statement, while this is preferred, the electronics can be provided with intelligence, so that if the key pin is broken, the electronics change the polarity of power pin 506 and power pin 508 if they are accidentally reversed. The assembly can be provided with a locking mechanism as exemplified by mating features hook 509 and slot 510.

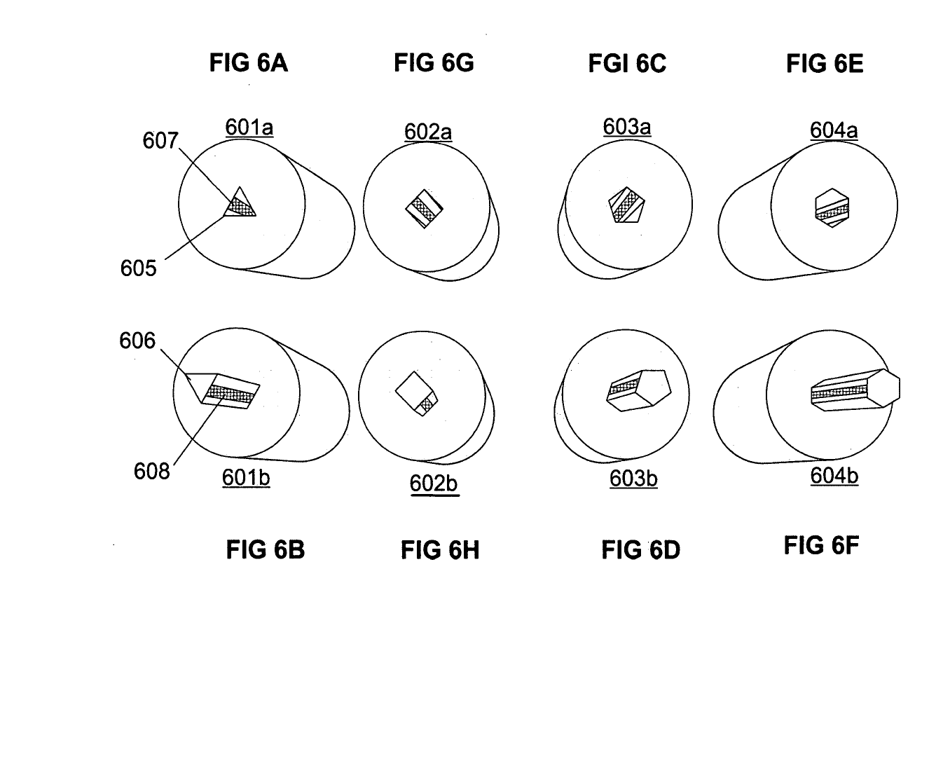

FIG. 6A, FIG. 6B, FIG. 6C, FIG. 6D, FIG. 6E, FIG. 6F, FIG. 6G and FIG. 6H provide examples of prospective embodiments of mating elements of the assemblies 601a, 601b, 601c, and 604a to respective assemblies 601b, 602b, 603b, and 604b. Example keying feature 606 provides an electrical connecting element 608 for making connection to slot 605 which has a mating electrical contact 607 to pass current electronics and electrical current.

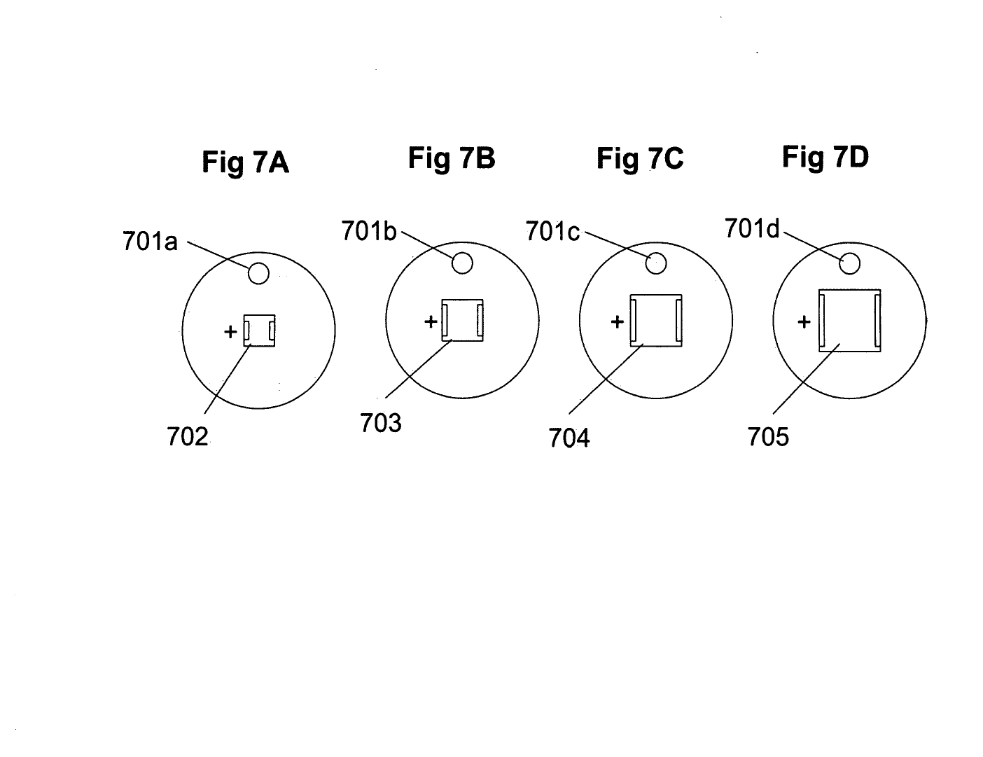

FIGS. 6A-6H and FIGS. 7A-D illustrate prospective embodiments to address different power input and output requirements for different LED assemblies. These example embodiments ensure that a user cannot inadvertently make connection between a transformer and an LED lamp assembly which are not suited to one another. One way to accomplish this is to use different shapes and spacing for electrical connections as shown in FIGS. 7A-7D. In the drawings, round pins 701a-701d are designed to mate with round holes (not shown) in respective mating halves while rectangular pins having electrical connections along the edges 702, 703, 704, and 705 are provided for making connections with respective mating elements (not shown). The rectangular pins and holes can be made of different sizes as illustrated in order to make certain that the user does not attempt to mate incompatible elements.

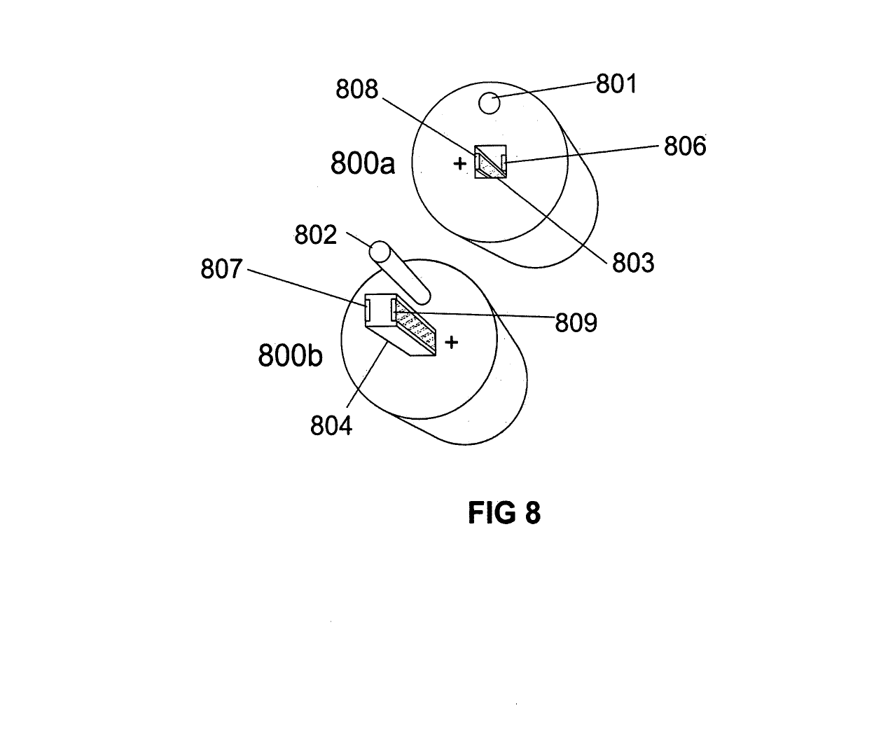

FIG. 8A and FIG. 8B provide a perspective view of one of a set of mating assembly elements as illustrated in FIGS. 7A-7D. The female half 800a has a receptacle opening 803 and a keying feature, hole 801. A positive contact 808 and a negative contact 806 are provided on the walls of the receptacle and the assembly is designed to receive the mating half 800b having a keying pin 802 to ensure proper polarity which will fit into hole 801 and a mating male connector 804 having a positive connection 809 and a negative connection 807 which will fit properly into receptacle 803 when joined together.

The features shown are illustrative only for purposes of understanding. However, any such feature type chosen can be advantageously standardized if desired to provide mating sets for different input and output voltages. There are many possible variations on the connection possibilities in terms of shape and size and thus the invention is not limited to the embodiments shown but derivative ideas which fall within the scope and intent of the invention are considered to be part of the invention.

Where the figures show Edison screw fittings, it is to be understood that these examples are used for the purpose of illustration only and that other fittings, including, but not limited to, electrode base mount, bayonet mount, and wedge base, are intended to be within the scope of the type of fittings contemplated by the invention.

In the event of a forced connection error, the transformer may be provided with intelligence to make adjustments to compensate for wrong polarity and differing input and output voltages

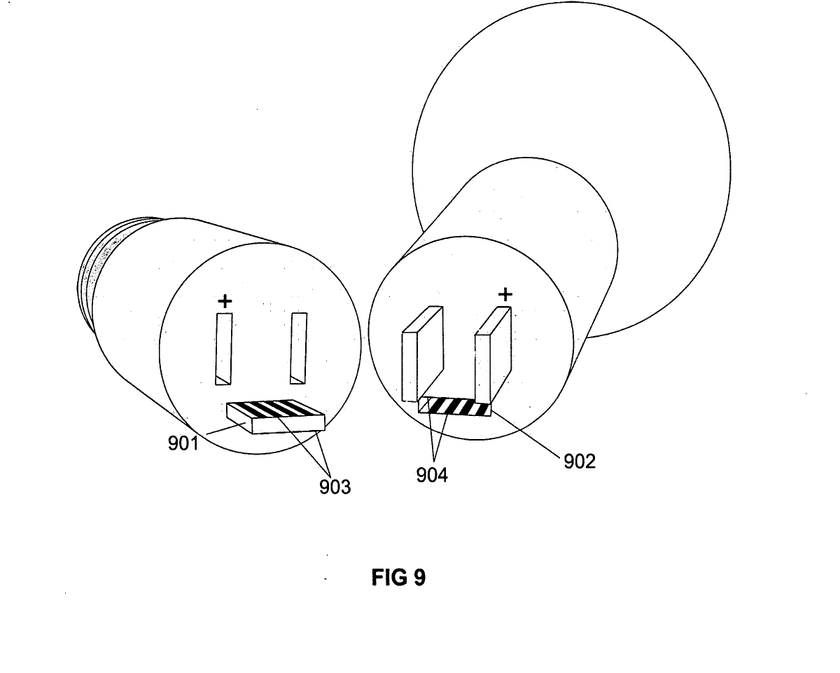

For advanced applications the LED light may serve as a wireless means of communication for creating lighting effects or information. In such applications the electronics may be desirably housed in the replaceable element of the assembly with the other electronic elements. FIG. 9A and FIG. 9B show a perspective view of such an embodiment where an electrical/electronic connector pair, tab 901 with edge connectors 903, fit into slot 902, having edge connector receptacles 904, serve a dual purpose of both aligning for polarity and communications.

Examples of other structures are herein offered to provide illustration without limitation, as any mechanical/electrical combination could serve to meet the intent of the invention. Moreover the invention easily lends itself to augmentation by other enhancements, including wireless operation and control and power monitoring purposes and objectives, a battery back-up for emergencies, and solar power for charging.

Furthermore, the electronic elements can be provided with a sensing system such as a MEMS (micro electromechanical system) device may be incorporated into the electrical/electronic assembly which allows the lighting to be activated or deactivated by any sensing system that does not require hard wiring or manual actions to activate the lighting assembly but which is activated by some other means including but not limited to: motion, vibration, sound, temperature, moisture or chemical sensing activators.

Although the invention has been described with reference to specific exemplary embodiments thereof, it will be evident that various modifications and changes may be made thereto without departing from the broader spirit and scope of the invention. The specification and drawings are, accordingly, to be regarded in an illustrative rather than a restrictive sense.

We claim:

1. An electrical/electronic module element comprising:
means for transforming alternating current (AC) to direct current (DC);
means for removeably and electrically connecting to a circuit; and
means for mechanically and electrically connecting to a light emitting diode (LED) element in a removable manner.

2. The electrical/electronic module element of claim 1 further comprising a battery.

3. The electrical/electronic module element of claim 2 further comprising circuitry to detect power fluctuation and to trigger the battery to provide power.

4. The electrical/electronic module element of claim 1 further comprising wireless control circuitry.

5. The electrical/electronic module element of claim 1 wherein the means for connecting to the LED element comprise means for ensuring unidirectional polarity.

6. The electrical/electronic module element of claim 5 wherein the means for ensuring unidirectional polarity is at least one selected from the group consisting of a pin, a key, a tab, and an edge connector.

7. The electrical/electronic module element of claim 1 wherein the means for transforming AC to DC includes means for converting a nominal 220 AC voltage to a lower DC voltage.

8. The electrical/electronic module element of claim 1 wherein the means for transforming AC to DC includes means for converting a nominal 120 AC voltage to a lower DC voltage.

9. The electrical/electronic module element of claim 7 wherein the lower DC voltage is in the range of 3 to 5 volts.

10. The electrical/electronic module element of claim 8 wherein the lower DC voltage is in the range of 3 to 5 volts.

11. The electrical/electronic module element of claim 1 wherein a means for making mechanical and electrical connection to the LED assembly is provided.

12. A means for mechanically and electrically connecting to the LED assembly in claim 11 which is at least one selected from the group consisting of Edison screw-cap fitting, electrode base mount, bayonet mount, wedge base, and power pin connection.

13. The electrical/electronic module element of claim 1 wherein the means for removeably and electrically connecting to the LED element is at least one selected from the group consisting of Edison screw-cap fitting, electrode base mount, bayonet mount, wedge base, and power pin connection.

14. The electrical/electronic module element of claim 1 further comprising circuitry to correct polarity.

15. A light emitting diode (LED) element comprising:
means for mechanically and electrically connecting in a removable manner to an electrical/electronic module element defined in claim 1.

16. The LED element of claim 14 wherein the means for making mechanical and electrical connection to the electrical/electronic module element is provided.

17. A means for mechanically and electrically connecting to the electrical/electronic module element assembly in claim 16 which is at least one selected from the group consisting of Edison screw-cap fitting, electrode base mount, bayonet mount, wedge base, and power pin connection.

18. The LED element of claim 14 wherein the means for connecting to the electrical/electronic module element comprise means for ensuring unidirectional polarity.

19. The LED element of claim 14 wherein the means for ensuring unidirectional polarity is at least one selected from the group consisting of a pin, a key, a tab, and an edge connector.

20. A light emitting diode (LED) assembly comprising:
two separable elements comprising a lighting element having at least one LED and an electrical/electronic module element.

21. The assembly of claim 18 wherein the two separable elements are electrically connected by at least one selected from the group consisting of Edison screw-cap fitting, electrode base mount, bayonet mount, wedge base, and power pin connection.

22. The assembly of claim 18 further comprising means for ensuring unidirectional polarity between the two separable elements.

23. An LED based electronic lighting assembly which is capable of being activated by integral sensors capable of sensing and activating based on interpretations of presence of electromagnetic activity, microwave signals, ultraviolet light, visible light, infrared light, motion, vibration, sound, temperature, moisture or specified chemical.

24. The electrical/electronic module element of claim 1 wherein there is provided additional electrical and electronic connections to facilitate communication between the LED portion of the assembly and the electrical/electronic module housing sensing elements identified in claim 21.
